(19) United States
(12) Patent Application Publication
(10) Pub. No.: US 2007/0157082 A1
(43) Pub. Date: Jul. 5, 2007

(54) Web portal layout manager system and method

(75) Inventors: Bruce William Green, Eden Prairie, MN (US); Jason S. Shapiro, St. Paul, MN (US)

Correspondence Address: BAKER BOTTS L.L.P., 2001 ROSS AVENUE, SUITE 600, DALLAS, TX, 75201-2980, US

(73) Assignee: COMPUTER ASSOCIATES THINK, INC.

(21) Appl. No.: 11/326,202

(22) Filed: Jan. 4, 2006

(51) Int. Cl. G06F 17/00

(52) U.S. Cl. 715/520; 715/517; 715/515; 715/513

(57) ABSTRACT

In accordance with the teachings of the present invention, a web portal layout manager system and method are provided. In particular embodiments of the present invention, the method includes receiving at a layout manager an indication selecting one of multiple predetermined layout types, receiving at the layout manager a set of portlets, receiving at the layout manager formatting properties for the portlets of the selected layout type, calling an executable component associated with the selected layout type to produce a code fragment specifying at least a portion of a web portal containing the set of portlets having the selected layout type and formatting properties, receiving an indication of content to populate the portlets of the web portal specified by the code fragment, and rendering the at least a portion of the web portal specified by the code fragment containing the indicated content.

### TECHNICAL FIELD

This disclosure relates generally to the field of web portal applications and, more specifically, to a web portal layout manager system and method.

### BACKGROUND

Web portals are web-based applications that provide a common interface for content aggregated from a variety of disparate sources. Typically, this content is displayed in a plurality of “portlets,” where each portlet is a subview within the major view of the web portal. Web portals are often produced using web portal applications that control the size and positioning of the portlets within the web portal. Using such an application, the portlets are often programmed statically, in a one-time operation, where the person designing the portal hard-codes the position, size, and content of each portlet into the coding of the web portal.

### SUMMARY

In accordance with the teachings of the present invention, a web portal layout manager system and method are provided. In particular embodiments of the present invention, the method comprises receiving at a layout manager an indication selecting one of multiple predetermined layout types, receiving at the layout manager a set of portlets, receiving at the layout manager formatting properties for the portlets of the selected layout type, calling an executable component associated with the selected layout type to produce a code fragment specifying at least a portion of a web portal containing the set of portlets having the selected layout type and formatting properties, receiving an indication of content to populate the portlets of the web portal specified by the code fragment, and rendering the at least a portion of the web portal specified by the code fragment containing the indicated content.

A technical advantage of particular embodiments of the present invention includes the ability to automate the generation of web portals of multiple layout types using a layout manager that calls upon executable components associated with the available layout types. This greatly simplifies the repetitive generation of web portals by encapsulating algorithms for positioning and sizing the portlets within the executable components. This allows the algorithms to be reused and simplifies the application code.

Another technical advantage of particular embodiments of the present invention includes the ability to generate multiple layout types by using a single layout manager. Furthermore, particular embodiments of the present invention may allow additional executable components, specifying additional layout types, to be added to the set of executable components that are callable by the layout manager. In this manner, the number and diversity of layout types the layout manager may generate may be easily increased.

Yet another technical advantage of particular embodiments of the present invention includes the ability to specify layout types in a way that is appropriate for the particular layout type. For example, particular embodiments may use heuristic methods to position and size the portlets specified by the executable components. In particular embodiments, the portlet types may be specified in table/grid or row/column format, by describing the position of the portlets relative to their position in the portal (e.g., top, left, right, bottom), or by describing the position of the portlets relative to each other (e.g., portlet A is below portlet B; portlet C is to the right of portlet A). This allows greater flexibility in how a portlet is specified.

Other technical advantages of the present invention may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and features and advantages thereof, reference is now made to the following description, taken in conjunction with the accompanying drawings, in which:

FIG. 1 illustrates a web portal application in accordance with a particular embodiment of the present invention;

FIG. 2 illustrates a plurality of web portal layouts in accordance with a particular embodiment of the present invention; and

FIG. 3 illustrates a flowchart of a method of rendering a web portal in accordance with a particular embodiment of the present invention.

### DESCRIPTION OF EXAMPLE EMBODIMENTS

In accordance with the teachings of the present invention, a web portal layout manager system and method are provided. In particular embodiments of the present invention, the method comprises receiving at a layout manager an indication selecting one of multiple predetermined layout types, receiving at the layout manager a set of portlets, receiving at the layout manager formatting properties for the portlets of the selected layout type, calling an executable component associated with the selected layout type to produce a code fragment specifying at least a portion of a web portal containing the set of portlets having the selected layout type and formatting properties, receiving an indication of content to populate the portlets of the web portal specified by the code fragment, and rendering the at least a portion of the web portal specified by the code fragment containing the indicated content. The use of such a layout manager allows web portal generation to be automated such that a single web portal layout may be reused to generate multiple web portals having different content and/or formatting. In particular embodiments of the present invention, the variety of web portals layouts capable of being produced by the layout manager is limited only by the executable components available to the layout manager. By making additional executable components corresponding to additional layout types available to the layout manager, those additional layout types may also be generated using the web layout manager.

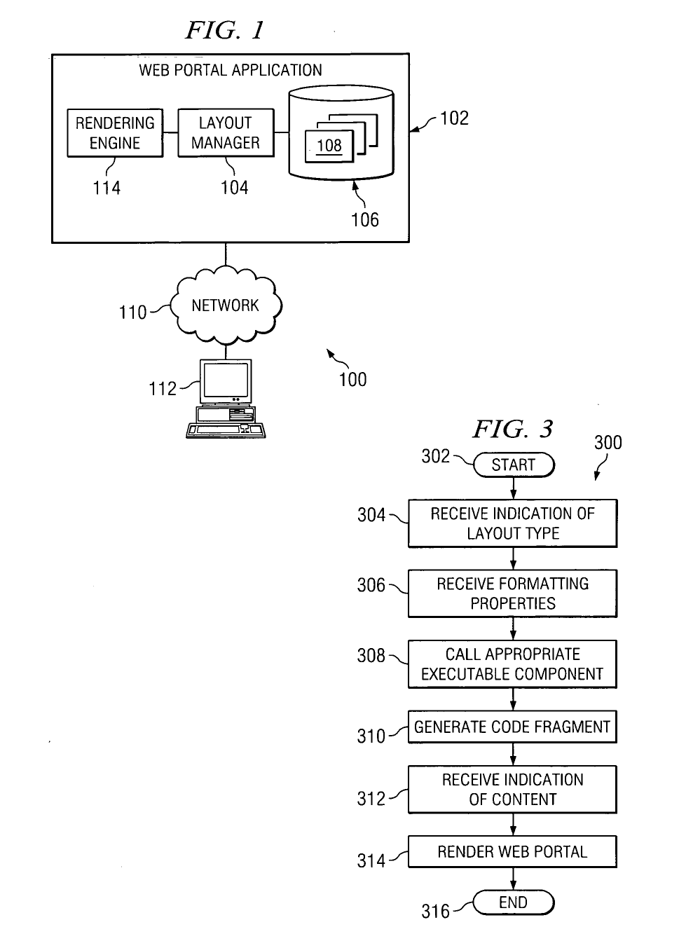

FIG. 1 illustrates a web portal system 100 in accordance with a particular embodiment of the present invention. Generally, web portal system 100 comprises a web portal application 102 connected to a user terminal 112 via network 110. Through network 110, which may include a local area network (LAN), wide area network (WAN), the Internet, or any other suitable network, a user at user terminal 112 may interact with web portal application 102 to produce a web portal in accordance with the teachings of the present invention.

As shown in FIG. 1, web portal application 102 comprises a layout manager 104 and a storage device 106, which stores a plurality of executable components 108 corresponding to a plurality of web portal layout types. Each layout type provides a method for composing a set of portlets in a specified arrangement within a web portal. As used herein, a “portlet ” is a web component, managed by a portlet container, that is used by a web portal as a pluggable user interface component that provides a presentation layer to one or more information systems, while a “layout manager ” refers to any combination of software and/or hardware that manages layout types for a web portal application. When called, layout manager 104 routes a request from web portal application 102 to the executable component 108 corresponding to the specified layout type and then returns the output of the executable component (i.e., a code fragment specifying at least a portion of a web portal) to the web portal application.

Generally, each layout type specified by executable components 108 provides a method for composing a set of portlets into a specified layout in a manner that is appropriate for that layout. In particular embodiments, this is accomplished using a variety of heuristic methods to position and size the portlets in a web portal. For example, in particular embodiments of the present invention, a plurality of portlets may be sized and positioned in a table/grid format or a row/column format. In particular embodiments of the present invention, portlets may also be sized and positioned relative to their position within the web portal itself. For example, portlets may be specified as being the “top, ” “left, ” “right, ” or “bottom ” portlet. In particular embodiments of the present invention, portlets may also be sized and positioned relative to the other portlets in the web portal. For example, portlet A may be specified as being below portlet B and to the right of portlet C. Thus, depending on the selected layout type, the corresponding executable component 108 may use the appropriate heuristic method to best position and size the portlets in a web portal.

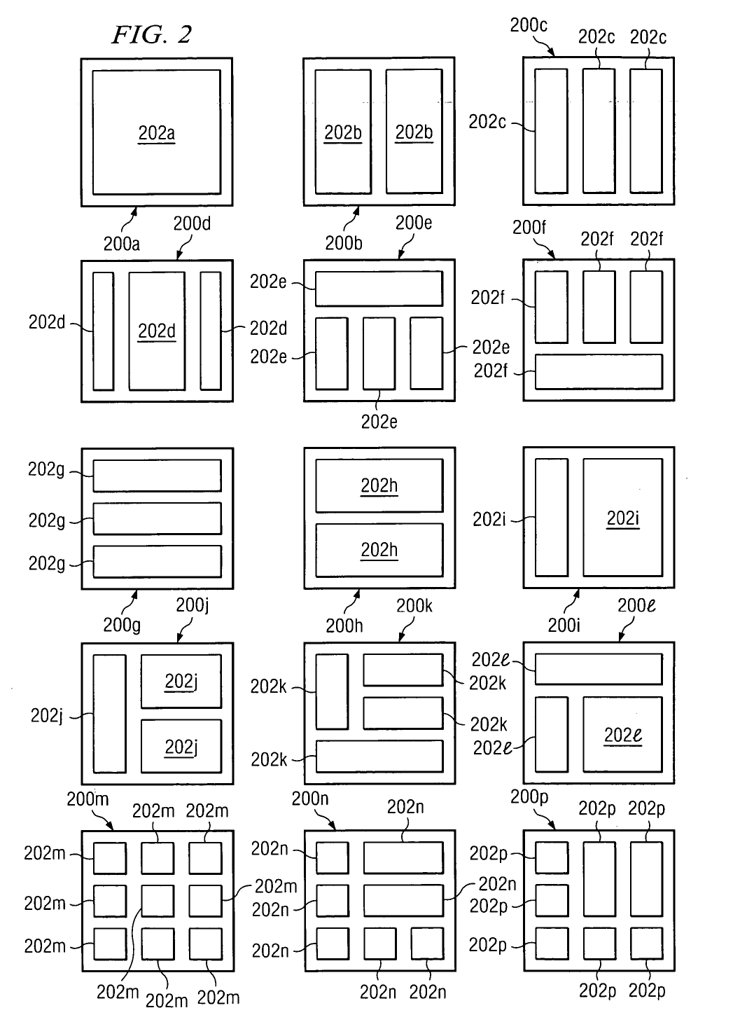

With this understanding, FIG. 2 illustrates a variety of web portal layouts types that may be used in accordance with the teachings of the present invention. Generally, each layout type comprises one or more portlets 202 arranged in a single web portal 200. In each of these layouts, the portlets 200 are arranged in a table format, with each portlet 202 spanning one or more rows or columns within the corresponding portal 200. For example, web portal 200a comprises a single portlet 202a, while web portal 200b comprises two portlets 202b arranged in a column layout. Other examples portal layouts include column layouts; as shown by portals 200c, 200d, and 200i; row layouts, as shown by portals 200g and 200h; and combination row-and-column layouts, as shown by portals 200e, 200f, 200j, 200k, 2001, 200m, 200n, and 200p.

Although FIG. 2 illustrates particular layouts that may be used in accordance with a particular embodiment of the present invention, the teachings of the present invention are not limited to the particular layouts described above, but may be extended to any other layout types that may be presented in an HTML table or similar mark-up language. Additionally, it should be understood that the example layouts depicted in FIG. 2 could all be generated by a single layout type or by a multiple layout types (one corresponding to each layout) depending on the particular embodiment of the present invention. Furthermore, it should be understood that the teachings of the present invention are not limited to table/grid or row/column formatted portals, but may be applied to any web portal layouts creating using heuristic methods including, but not limited to, those described above.

Referring back to FIG. 1, layout manager 104 receives an indication selecting one of the layout types and formatting properties for a selected layout type from the user at terminal 112. In particular embodiments, these formatting properties may include the number of portlets, an ID for each portlet, a height and/or width for each portlet, an amount of cell padding for each portlet, an order value for each portlet, and/or any other suitable formatting information. Layout manager 104 then calls the executable component 108 associated with the selected layout type and passes the formatting properties received from user terminal 112 to the executable component 108. The executable component 108 then produces a code fragment, typically in HTML format, specifying at least a portion of a web portal having the selected layout type and formatting properties received from user terminal 112 and returns the code fragment to layout manager 104

In particular embodiments, the code fragment returned to layout manager 104 from executable component 108 is devoid of content, i.e., each portlet is essentially a shell into which content may be placed. Therefore, particular embodiments of web portal application 102 also include a rendering engine 114 which places content into the web portal specified by the code fragment produced by executable component 108. In particular embodiments, rendering engine 114 may receive an indication of content to be placed in the web portal from user 112, which rendering engine 114 then retrieves and places in the web portal. In some embodiments, rendering engine 114 may simply receive the content directly from user terminal 112 and place the content in the web portal. Rendering engine 114 then returns a web portal containing the indicated content to user terminal 112.

A better understanding of the present invention may be had by making reference to FIG. 3, which illustrates flowchart 300 of a method of producing a web portal in accordance with a particular embodiment of the present invention. Flowchart 300 starts at block 302. The layout manager 104 then receives an indication selecting one of the predetermined layout types from a user at block 304, and formatting properties for the selected layout type at block 306.

Layout manager 104 then passes the formatting properties received from the user to the executable component 108 associated with the selected layout type at block 308. The executable component 108 generates a code fragment specifying a web portal of the selected layout type having the specified formatting properties received from the user and returns the code fragment to layout manager 108 at block 310.

At this stage in flowchart 300, the code fragment returned by the executable component 108 contains only formatting information for the selected layout, not content. Therefore, particular embodiments of the present invention may rely on a separate rendering engine 114 to populate the portlets of the web portal specified by the code fragment with content. In such an embodiment, flowchart 300 continues on in block 312, where the rendering engine 114 receives an indication of content to populate the portlets of the portal specified by the code fragment. In particular embodiments, the rendering engine 114 may then retrieve the content specified by the indication. In some embodiments, the rendering engine 114 may receive the content with the indication itself. Regardless of the source of the content, the rendering engine 114 then returns a web portal of the selected layout type having the selected content at block 314. Flowchart 300 then terminates at block 316.

By employing a layout manager 104 that calls upon multiple executable components 108, each associated with a predetermined layout type, to generate a code fragment embodying a selected layout type, particular embodiments of the present invention offer the ability to significantly automate the generation of web portals. Similarly, particular embodiments of the present also offer the ability to make additional layout types available to the layout manager 104 by simply adding additional executable components 108 representing those layout types to storage device 106. This allows for a flexible, dynamic approach to generating web portals.

Although particular embodiments of the method and apparatus of the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A method for rendering a web portal, comprising:
receiving at a layout manager an indication selecting one of multiple predetermined layout types;
receiving at the layout manager a set of portlets;
receiving at the layout manager formatting properties for the portlets of the selected layout type;
calling an executable component associated with the selected layout type to produce a code fragment specifying at least a portion of a web portal containing the set of portlets having the selected layout type and formatting properties;
receiving an indication of content to populate the portlets of the web portal specified by the code fragment; and
rendering the at least a portion of the web portal specified by the code fragment containing the indicated content.

2. The method of claim 1, wherein the code fragment comprises HTML.

3. The method of claim 1, wherein the executable component positions the portlets according to one or more heuristic methods.

4. The method of claim 1, wherein the formatting properties comprise placement information for each of the portlets within the web portal.

5. The method of claim 1, wherein the formatting properties comprise width values for each of the portlets within the web portal.

6. The method of claim 1, wherein the formatting properties comprise height values for each of the portlets within the web portal.

7. The method of claim 1, wherein the formatting properties comprise cell padding information.

8. The method of claim 1, wherein the formatting properties comprise order values for the set of portlets.

9. A method for rendering a web portal, comprising:
receiving at a layout manager an indication selecting one of multiple predetermined layout types;
receiving at the layout manager a set of portlets;
receiving at the layout manager formatting properties for the portlets of the selected layout type; and
calling an executable component associated with the selected layout type to produce a code fragment specifying at least a portion of a web portal containing the set of portlets having the selected layout type and formatting properties.

10. The method of claim 9, wherein the code fragment comprises HTML.

11. The method of claim 9, wherein the executable component positions the portlets according to one or more heuristic methods.

12. The method of claim 9, wherein the formatting properties comprise placement information for each of portlets within the web portal.

13. The method of claim 9, wherein the formatting properties comprise width values for each of the portlets within the web portal.

14. The method of claim 9, wherein the formatting properties comprise height values for each of the portlets within the web portal.

15. The method of claim 9, wherein the formatting properties comprise cell padding information.

16. The method of claim 9, wherein the formatting properties comprise order values for the set of portlets.

17. A web portal application, comprising:
a plurality of executable components, each associated with a respective predetermined layout type and operable to generate a code fragment specifying at least a portion of a web portal of the associated layout type; and
a layout manager operable to receive a set of portlets, an indication selecting one of the multiple predetermined layout types, and formatting properties for the selected layout type, and further operable to call the executable component associated with the selected layout type to generate a code fragment specifying at least a portion of a web portal containing the set of portlets having the selected layout type and formatting properties.

18. The web portal application of claim 17, further comprising a rendering engine operable to receive an indication of content to populate the portlets of the web portal specified by the code fragment, and further operable to render the web portal specified by the code fragment containing the indicated content.

19. The web portal application of claim 17, wherein the code fragment comprises HTML.

20. The web portal application of claim 17, wherein each of the layout types comprise a predetermined arrangement of portlets within the web portal.

21. The web portal application of claim 17, wherein the executable components position the portlets according to one or more heuristic methods.

22. The web portal application of claim 17, wherein the formatting properties comprise placement information for each of the portlets within the web portal.

23. The web portal application of claim 17, wherein the formatting properties comprise width values for each of the portlets within the web portal.

24. The web portal application of claim 17, wherein the formatting properties comprise height values for each of the portlets within the web portal.

25. The web portal application of claim 17, wherein the formatting properties comprise cell padding information.

26. The web portal application of claim 17, wherein the formatting properties comprise order values for the set of portlets.
